(19) United States
(12) Patent Application Publication
(10) Pub. No.: US 2024/0246224 A1
(43) Pub. Date: Jul. 25, 2024

(54) EXOSKELETON TO BE WORN BY A SUBJECT

(71) Applicant: BIOLIFT TECHNOLOGIES INC., Boucherville (CA)

(72) Inventors: Mathieu RAMANANARIVO, Montreal (CA); Laurent BLANCHET, Bromont (CA); Samuel LECOURS, Longueuil (CA); Pauline CAMUS, Montreal (CA)

(73) Assignee: BIOLIFT TECHNOLOGIES INC., Boucherville, QC (CA)

(21) Appl. No.: 18/564,399

(22) PCT Filed: Jun. 1, 2022
(86) PCT No.: PCT/IB2022/055147

§ 371 Date: Nov. 27, 2023

Related U.S. Application Data
(60) Provisional application No. 63/202,229, filed on Jun. 2, 2021.

(51) Int. Cl. B25J 9/00

(52) U.S. Cl. CPC B25J 9/0006

(57) ABSTRACT

An exoskeleton comprising a top portion, a bottom portion, left and right thigh portions, and left and right exoskeleton mechanisms comprising: left and right hip base members, left and right hip members mounted to the left and right hip base members, left and right thigh members, the left and right proximal ends of the left and right thigh members being mounted to the left and right hip base members and the left and right distal ends of the left and right thigh portions being mounted to the left and right thigh portions, left and right back members operatively connected to the left and right hip base members, left and right spring-loaded mechanisms operatively connecting the left and right back members to the left and right hip base members, and left and right sliding members comprising left and right top ends mounted to the top portion of the exoskeleton.

### FIELD

The present technology relates to an exoskeleton to be worn by a subject.

### BACKGROUND

Workplace injuries are the 2nd leading cause of disability in the world. According to the Institut National de Santé Publique du Québec (INSPQ), approximately 25% of workers (Tissot et al. 2020) live with pain due to a musculoskeletal disorder (MSD) caused by a workplace injury.

The most common injuries or lesions among workers are tendonitis, bursitis, epicondylitis and sprains, which generally occur in the back, shoulders, neck, elbows or wrists in descending order of importance. The main causes of these injuries are: handling heavy loads, repetitive movements, unusual, uncomfortable or prolonged static positions, vibrations, insufficient recovery time and a fast-paced work environment (Gélinas et al., 2019). Depending on the severity of these injuries, they result in an absence from work ranging from a few weeks to several months and, in some cases, can lead to permanent worker disability. These injuries involve significant costs for both the employer and society (Gélinas et al., 2019).

In recent years, robotics and automation have made it possible to replace the role of workers in many high-risk injury tasks. However, there are still many tasks that benefit from the human precision, skills and movement capabilities unique to workers (Huysamen et al., 2018). To assist workers in their tasks and reduce exposure to injuries, the use of exoskeleton devices is a promising avenue. Indeed, these devices allow mechanical power to be transferred from the exoskeleton to the human body, thus reducing the biomechanical efforts to be developed by the worker. For back injuries, which are the most occurring work related injuries, a back exoskeleton can be used to reduce lower and upper back strain by redistributing the effort through the exoskeleton.

In addition to the exoskeleton's main objective of physical assistance, it must also be well adjusted and comfortable in order to ensure user acceptance of the technology. To achieve this, it is essential to allow the user to move freely with the exoskeleton. In another way, the exoskeleton should not impair the complex movements of the human body, especially for torso movements.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

In accordance with a broad aspect, there is provided an exoskeleton to be worn by a subject having left and right shoulders, left and right armpits, a chest, an abdomen, left and right hips, a back, a buttock, and left and right thighs, the exoskeleton comprising: a top portion adapted to be worn on the subject's left and right shoulders and chest; a bottom portion adapted to be worn on the left and right hips and back, the bottom portion comprising left and right flaps covering at least partially left and right sides of the left and right hips and thighs; left and right thigh portions adapted to be worn on the subject's left and right thighs; and left and right mechanisms each comprising: an abduction-adduction joint coupled to the bottom portion, a flexion-extension joint located above the abduction-adduction joint, the flexion-extension joint being operatively connected to the abduction-adduction joint, a spring-loaded mechanism located above the flexion-extension joint, the spring-loaded mechanism being operatively connected to the flexion-extension joint, the spring-loaded mechanism being configured for transmitting a force to aid a hip extension movement of the subject, a thigh member operatively connected to the thigh portion and to the abduction-adduction joint, and a sliding mechanism operatively connected to the spring-loaded mechanism and to the top portion, the sliding mechanism being configured for varying its length to enable a lateral flexion and a lateral extension of the subject.

In accordance with another broad aspect, there is provided an exoskeleton to be worn by a subject having left and right shoulders, left and right armpits, a chest, an abdomen, left and right hips, a back, a buttock, and left and right thighs, the exoskeleton comprising: a top portion adapted to be worn on the subject's left and right shoulders and chest; a bottom portion adapted to be worn on the subject's left and right hips and back, the bottom portion comprising left and right flaps covering at least partially left and right sides of the subject's left and right hips and left and right thighs; left and right thigh portions adapted to be worn on the subject's left and right thighs; and left and right exoskeleton mechanisms comprising: (i) left and right hip base members mounted to the left and right flaps of the bottom portion, (ii) left and right hip members mounted to the left and right hip base members, (iii) left and right thigh members extending between left and right proximal ends and left and right distal ends, the left and right proximal ends of the left and right thigh members being mounted to the left and right hip base members and the left and right distal ends of the left and right thigh portions being mounted to the left and right thigh portions, (iv) left and right back members operatively connected to the left and right hip base members, (v) left and right spring-loaded mechanisms operatively connecting the left and right back members to the left and right hip base members, and (vi) left and right sliding members comprising left and right top ends mounted to the top portion of the exoskeleton, wherein movements of the left and right thigh members impart rotational movement of the left and right hip members at left and right abduction-adduction joints, wherein movements of the left and right back members impart rotational movement of the left and right back members relative to the left and right hip base members at left and right flexion joints, and wherein the left and right sliding members are slidably movable relative to the left and right back members such that left and right lengths of the left and right sliding members vary upon a lateral flexion and/or a lateral extension of the subject.

In accordance with a further broad aspect, there is provided an exoskeleton to be worn by a subject having left and right shoulders, left and right armpits, a chest, an abdomen, left and right hips, a back, a buttock, and left and right thighs, the exoskeleton comprising: a top portion adapted to be worn on the subject's left and right shoulders and chest; a bottom portion adapted to be worn on the subject's left and right hips and back, the bottom portion comprising left and right flaps covering at least partially left and right sides of the subject's left and right hips and left and right thighs; left and right thigh portions adapted to be worn on the subject's left and right thighs; and left and right exoskeleton mechanisms comprising: (i) left and right hip base members mounted to the left and right flaps of the bottom portion, (ii) left and right hip members mounted to the left and right hip base members, (iii) left and right thigh members extending between left and right proximal ends and left and right distal ends, the left and right proximal ends of the left and right thigh members being mounted to the left and right hip base members and the left and right distal ends of the left and right thigh portions being mounted to the left and right thigh portions, (iv) left and right back members operatively connected to the left and right hip base members, (v) left and right spring-loaded mechanisms operatively connecting the left and right back members to the left and right hip base members, and (vi) left and right sliding members comprising left and right top ends mounted to the top portion of the exoskeleton and left and right bottom ends slidably engaging with the left and right back members, wherein movements of the left and right thigh members impart rotational movement of the left and right hip members at left and right abduction-adduction joints, wherein movements of the left and right back members impart rotational movement of the left and right back members relative to the left and right hip base members at left and right flexion-extension joints, wherein the left and right sliding members are movable relative to the left and right back members such that left and right lengths of the left and right sliding members vary upon a lateral flexion and/or a lateral extension of the subject, and wherein the left and right spring-loaded mechanisms comprise left and right bottom ends operatively connected to the left and right hip base members and left and right top ends operatively connected to the left and right back members, wherein the left and right spring-loaded mechanisms are adapted to transfer a force to aid movement of the subject's left and/or right hips.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a reference diagram of a body of a subject and the three primary planes of movement.

FIG. 2 illustrates a front elevation and left elevation of an exoskeleton in accordance with a first embodiment worn by a subject.

FIG. 3 illustrates a plurality of positions adopted by the subject wearing the exoskeleton of FIG. 2.

FIG. 4 illustrates a left-side elevation of the subject wearing the exoskeleton in a straight position, in a hip flexion position and in a right hip abduction position in accordance with one or more non-limiting embodiments of the present technology.

FIG. 5 illustrates forces generated by the spring-loaded mechanism of the exoskeleton worn by the subject during a hip flexion movement.

FIG. 6 illustrates a detailed front elevation of the torso attachment and the left torso interface connecting an upper section of the left exoskeleton mechanism in accordance with the first embodiment.

FIG. 7 illustrates an enlarged right elevation and a front elevation of the hip attachment and the left hip interface connecting to the left exoskeleton mechanism in accordance with the first embodiment.

FIG. 8 illustrates an enlarged right elevation of the left thigh attachment and the left thigh interface connecting a bottom section of the left exoskeleton mechanism in accordance with the first embodiment.

FIG. 9 illustrates a right elevation sectional view left exoskeleton mechanism in accordance with the first embodiment.

FIG. 10 illustrates an enlarged front elevation of a midsection of the subject wearing the exoskeleton in accordance with the first embodiment.

FIG. 11 illustrates a right elevation of the subject wearing the exoskeleton in accordance with the first embodiment and performing trunk rotations.

FIG. 12 illustrates a front perspective view taken from the bottom of the subject wearing the exoskeleton in accordance with the first embodiment and performing trunk rotations.

FIG. 13 illustrates a detailed elevation of the right thigh attachment and the right thigh interface connecting a bottom section of the right exoskeleton mechanism in accordance with the first embodiment.

FIG. 14 shows a front perspective view of an exoskeleton in accordance with a second embodiment and being worn by a subject.

FIG. 15 shows a rear perspective view of the exoskeleton of FIG. 14 worn by the subject.

FIG. 16 shows a front elevational view of the exoskeleton of FIG. 14 worn by the subject.

FIG. 17 shows a rear elevational view of the exoskeleton of FIG. 14 worn by the subject.

FIG. 18 shows a left elevational view of the exoskeleton of FIG. 14 worn by the subject, without the right arm.

FIG. 19 shows a right elevational view of the exoskeleton of FIG. 14 worn by the subject, without the left arm.

FIG. 20 shows an enlarged view of the left hip base member and the left hip member with the left cover in a first position.

FIG. 21 shows an enlarged view of the left hip base member and the left hip member without the left cover.

FIG. 22 shows internal components of the left hip base member and the left hip member of FIGS. 20 and 21 wherein the left hip member is freely rotationable relative to the left hip base member.

FIG. 23 shows an enlarged view of the left hip base member and the left hip member with the left cover in a second position.

FIG. 24 shows an enlarged view of the left hip base member and the left hip member without the left cover.

FIGS. 25 and 26 show internal components of the left hip base member and the left hip member of FIGS. 23 and 24 wherein the left hip member and the left hip base member are locked together such that the left spring-loaded mechanism transfers a force to aid movement of the subject's left hip.

FIG. 27 shows the left sliding member, the left back member, the left spring-loaded mechanism, the left hip base member, the left hip member without the cover, the left thigh member, and the left thigh portion, wherein the left hip member and the left hip base member are locked together such that the left spring-loaded mechanism transfers a force to aid movement of the subject's left hip and wherein the left sliding member and the left back member are in a first inclined position.

FIG. 28 shows an enlarged view of the left back member, the left spring-loaded mechanism, the left hip base member, the left hip member without the cover, the left thigh member, and the left thigh portion of FIG. 27.

FIG. 29 shows the left sliding member, the left back member, the left spring-loaded mechanism, the left hip base member, the left hip member without the cover, the left thigh member, and the left thigh portion, wherein the left hip member and the left hip base member are locked together such that the left spring-loaded mechanism transfers a force to aid movement of the subject's left hip and wherein the left sliding member and the left back member are in a second inclined position, the first position corresponding to a position wherein the subject's trunk is bent forwardly at about 80° and the second position corresponding to a position wherein the subject's trunk is bent forwardly at about 15°.

FIG. 30 shows an enlarged view of the left back member, the left spring-loaded mechanism, the left hip base member, the left hip member without the cover, the left thigh member, and the left thigh portion of FIG. 29.

FIG. 31 shows an enlarged view of the left hip base member and the left hip member with the left cover in a third position.

FIG. 32 shows an enlarged view of the left hip base member and the left hip member without the left cover.

FIG. 33 shows internal components of the left hip base member and the left hip member of FIGS. 31 and 32 wherein the left hip member is freely rotationable relative to the left hip base member, wherein the engaging member is free to move as a pendulum, and wherein the left back member is in a position corresponding to a position wherein the subject's trunk is generally straight.

FIG. 34 shows the left sliding member, the left back member, the left spring-loaded mechanism, the left hip base member, the left hip member without the cover, the left thigh member, and the left thigh portion, wherein the engaging member is pivoted up to a position wherein the left hip member and the left hip base member are locked together such that the left spring-loaded mechanism transfers a force to aid movement of the subject's left hip and wherein the subject's trunk is bent forwardly at about 15° to about 25°.

FIG. 35 shows an enlarged view of the left hip base member and the left hip member without the left cover wherein the engaging member is pivoted up to a position wherein the left hip member and the left hip base member are locked together.

FIG. 36 shows internal components of the left hip base member and the left hip member of FIG. 35.

### DETAILED DESCRIPTION OF EMBODIMENTS

In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. The use of “including,” “comprising,” or “having” and variations thereof herein is meant to encompass the items listed thereafter and equivalents thereof as well as additional suitable items. Unless specified or limited otherwise, the terms “mounted,” “connected,” “supported,” and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

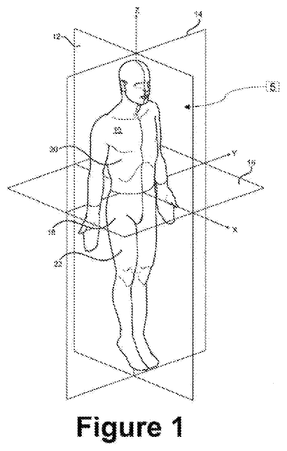

Variants, examples and preferred embodiments of the invention are described hereinbelow. FIG. 1 is a reference diagram of a body 10 of a human user or subject 5 illustrating three primary planes of movement, as is known in the art. As used herein, a sagittal plane 12 is coplanar with the X axis and the Z axis, defining a plane that vertically divides the body 10 in right and left halves.

A frontal plane 14 is illustrated as a plane that is coplanar with the Y axis and the Z axis, vertically dividing the body 10 of the human user in front and back halves.

A transverse plane 16 is illustrated as a plane that is coplanar with the X axis and Y axis, horizontally dividing the body 10 in top and bottom halves.

In a normal human body 10, pelvis and hips 18 allows rotation of an upper body 20 of the human user with three degrees of freedom, i.e., about the sagittal plane 12, the frontal plane 14, and the transverse plane 16. Similarly, the pelvis and hips 18 also allows each thigh 22 to also rotate with respect to the pelvis 18 with three degrees of freedom.

With these fundamentals in place, we will now consider some non-limiting examples to illustrate various implementations of aspects of the present technology.

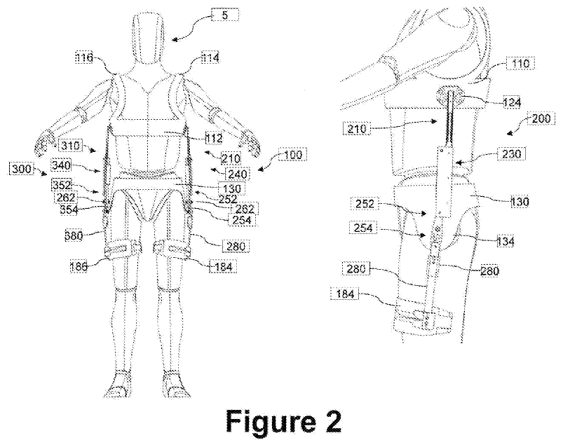

With reference to FIG. 2, there is depicted an exoskeleton 100 worn by a subject 5 in accordance with one or more non-limiting embodiments of the present technology.

The exoskeleton 100 is a rigid mechanism comprising a series of rotational and translational joints that allow freedom of movement of the subject's 5 hips and lower back. The maximum freedom of movement lets the subject 5 move freely and normally, therefore not creating discomfort by unusual movements or postures.

The exoskeleton 100 can provide physical assistance for a large variety of tasks that require bending (i.e., flexion) motions. For example, the exoskeleton 100 provides enough comfort to be worn throughout a full workday and does not need to be removed to accomplish certain tasks (but may be removed for other types of tasks), which would not be possible with some prior lower back exoskeletons.

The configuration of the components of the exoskeleton 100 enables the exoskeleton 100 to fit users with different heights without the use of additional straps or other fitting systems.

The maximum freedom of movement provided by the exoskeleton 100 lets the subject move freely and normally, therefore not creating any disequilibrium that could be caused by usual motion or postures. If a disequilibrium were to occur, the subject 5 is able to move quickly to avoid a fall or injury.

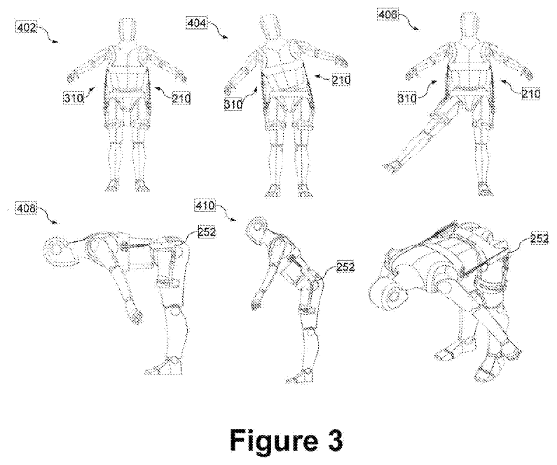

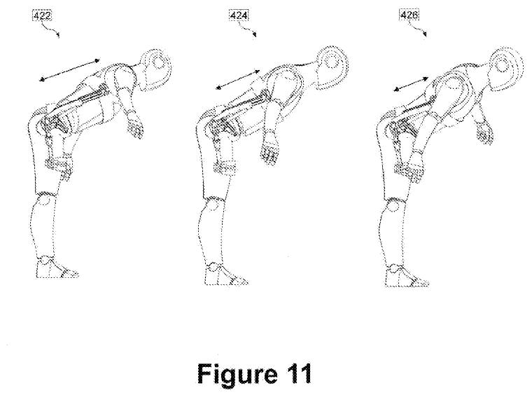

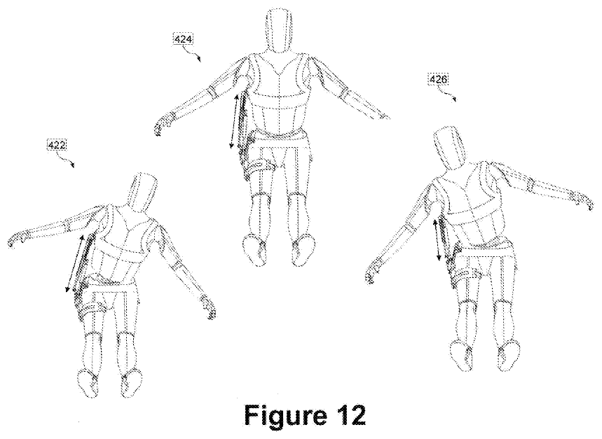

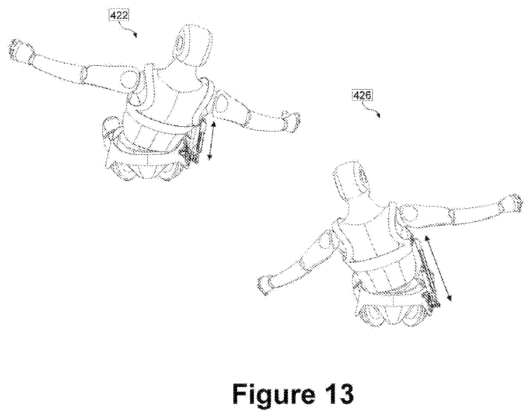

With brief reference to FIG. 3, to FIG. 11 and to FIG. 13, there are illustrated a plurality of positions taken by the subject 5 when wearing the exoskeleton 100 showing the freedom of movement. The subject 5 wearing the exoskeleton 100 may be in a standing position 402, perform a right lateral hip flexion 404 and a left lateral hip flexion (not illustrated) in the frontal plane 14, perform a right hip abduction 406 and a left hip abduction (not illustrated), perform a 90° hip extension 408 in the sagittal plane 12, a 45° hip extension 410 in the sagittal plane 12. The subject 5 may also perform trunk rotation movements or combination of hip frontal flexions and hip lateral flexions at different angles 422, 424, 426.

Referring now to FIG. 3 and FIG. 6 to FIG. 8, the exoskeleton 100 comprises body-mechanisms interfaces (represented collectively by reference numerals 100) for linking the exoskeleton 100 to the human body 10, as well as exoskeleton articulations and spring-loaded mechanism in the form of the left exoskeleton mechanism 200 and the right exoskeleton mechanism 300 each adapted to be worn on a respective side of the body 10 of the subject 5 parallel to the sagittal plane 12.

The body mechanism interfaces comprise inter alia a torso attachment 110, a waist attachment 130 and a pair of thigh attachments 180 comprising a left thigh attachment 184 and a right thigh attachment 186.

The torso attachment 110 comprises a torso belt 112 connected to a left shoulder strap 114 and a right shoulder strap 116. The torso attachment 110 is generally made of textile with rigid inserts for coupling the exoskeleton 100 to the upper body 20 of the subject 5.

The torso belt 112 is adapted to be worn around the subject's 5 chest or torso with the left shoulder strap 114 going over the left shoulder of the subject 5 and the right shoulder strap 116 going over the right shoulder of the subject 5. The left shoulder strap 114 and the right shoulder strap 116 are adjustable and enable positioning the exoskeleton 100 on the chest of the body 10.

The torso belt 112 comprises a left torso interface 124 coupled to the left exoskeleton mechanism 200 and a right torso interface 126 coupled to the right exoskeleton mechanism 300. The left torso interface 124 is located under the subject's left armpit when worn by the subject 5 and the right torso interface 126 is located under the subject's right armpit when worn by the subject 5. It will be appreciated that the torso attachment 110 may comprise foam pads disposed on an interior surface thereof for comfort of the subject 5.

The left and right torso interfaces 124, 126 are made of a sufficiently rigid material for coupling the torso belt 112 to the left and right exoskeleton mechanisms 200, 300 and act as anchors for receiving and transmitting forces to the left and right exoskeleton mechanisms 200, 300. As illustrated herein, the left and right torso interfaces 124, 126 are fastened to the torso belt 112 via bolts. It will be appreciated that the left and right torso interfaces 124, 126 may be secured to the torso belt 112 using different means, such as, but not limited to stitching, fastening, snapping, or a combination thereof.

The waist attachment 130 or waist harness 130 is adapted to be worn around a waist of the subject 5. The waist attachment 130 is generally made of textile and adjustable for fitting different waist sizes. In one embodiment, the waist attachment 130 comprises an adjustable front strap with a buckle (not illustrated) and back straps that may be made using hook-and-loop fasteners (not illustrated).

It will be appreciated that the waist attachment 130 may comprise foam pads disposed on an interior surface thereof for comfort of the subject 5.

The waist attachment 130 comprises a left waist flap 134 and a right waist flap 136. The left waist flap 134 and the right waist flap 136 each extend downwardly on a respective side of the lower body along the respective femurs of the subject 5.

The left waist flap 134 comprises a left flap interface 140 coupled to the left exoskeleton mechanism 200 and the right waist flap 136 comprises a right flap interface 150 coupled to the right exoskeleton mechanism 300. When the exoskeleton 100 is worn by the subject 5, the waist attachment 130 may be adjusted such that the left flap interface 140 is aligned with the left femoral joint of the subject 5 and the right flap interface 150 is aligned with the right femoral joint of the subject 5.

The left flap interface 140 and the right flap interface 150 are secured to the left waist flap 134 and the right waist flap 136 respectively and are made of sufficiently rigid material to act as anchor points and support at least in part the left and right exoskeleton mechanisms 200, 300. It will be appreciated that the left and right flap interfaces 140, 150 may be secured to the left and right waist flap 134, 136 using different means, such as, but not limited to stitching, fastening, snapping, or a combination thereof.

The pair of thigh attachments 180 comprises a left thigh attachment 184 adapted to be worn around at least a portion of the left thigh of the subject 5 and a right thigh attachment 186 adapted to be worn around at least a portion of the right thigh of the subject 5. The left thigh attachment 184 and the right thigh attachment 186 are made of plastic and comprise adjustable straps (not illustrated) to fit around different thigh sizes. It will be appreciated that left thigh attachment 184 and the right thigh attachment 186 may also be made from other materials such as fabric, plastic or a combination thereof. It will be appreciated that the left thigh attachment 184 and right thigh attachment 186 may comprise foam pads disposed on an interior surface thereof for comfort of the subject 5.

The left thigh attachment 184 comprises a left thigh interface 194 for coupling the left thigh of the subject 5 to the left exoskeleton mechanism 200 and the right thigh attachment 186 comprises a right thigh interface 196 for coupling the right thigh of the subject 5 to the right exoskeleton mechanism 300.

The left and right thigh interfaces 194, 196 are made from a rigid material and act as anchors for receiving forces from and transmitting forces to the left and right exoskeleton mechanisms 200, 300 while providing comfort to the subject 5.

The left exoskeleton mechanism 200 will now be described in more detail. It will be appreciated that the right exoskeleton mechanism 300 comprises the same components and is configured in a manner similar to the left exoskeleton mechanism 200 and will only be partially described.

An upper section of the left exoskeleton mechanism 200 comprises a left torso sliding mechanism 210 rotatively coupled to the left torso interface 124. The left sliding mechanism 210 comprise an upper guiding member 212 coupled to the left torso interface 124, a sliding member 214 slidably engaging the upper guiding member 212 and a bottom guiding member 216 slidably engaging the sliding member 214, the bottom guiding member 216 being coupled to a left housing 230.

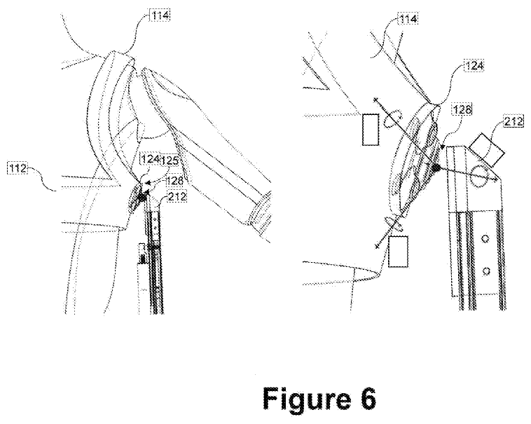

In one embodiment, as best seen in FIG. 6, the left torso interface 124 comprises a socket 125 for receiving a corresponding ball joint 128 of the left exoskeleton mechanism 200. In one embodiment, the socket 125 and corresponding ball joints 128 are made of metal. The ball joint connection between the torso belt and the left exoskeleton mechanism 200 may limit the possible angles of rotation of the left exoskeleton mechanism 200 within a predetermined range and provides resistance to rotative motions of the left exoskeleton mechanism 200 to the torso attachment 110. In one or more alternative embodiments, the ball joint connection between the torso belt and the left exoskeleton mechanism 200 may be made from rubber.

The ball joint connection between the left torso interface 124 and the left exoskeleton mechanism 200 enables maintaining the position of the contact surface of the exoskeleton mechanism 200 and provides freedom of movement to the torso and upper body 20 of the subject 5.

The upper guiding member 212 and the bottom guiding member 216 each define an interior channel for receiving the sliding member 214. The left sliding mechanism 210 is configured or operable to vary a length of the left exoskeleton mechanism 200 to enable a lateral flexion and extension of the upper body of the subject 5 and thus provide freedom of movement to the subject 5. The left sliding mechanism 210 follows the movements of the trunk of the subject 5 without restricting movements having components in the frontal plane (e.g., lateral flexions and abductions).

The left and right sliding mechanisms 210, 310 enable the subject 5 wearing the exoskeleton 100 to perform a plurality of movements such as lateral hip flexion and extension, hip abduction and adduction, a combination of lateral hip flexion and extension and frontal hip flexion and extension, as well as trunk rotations. The subject 5 may move freely and without resistance from components of the exoskeleton 100 when performing trunk movements.

In one embodiment, the sliding member 214 may be fixed to one of the upper guiding member 212 and the bottom guiding member 216.

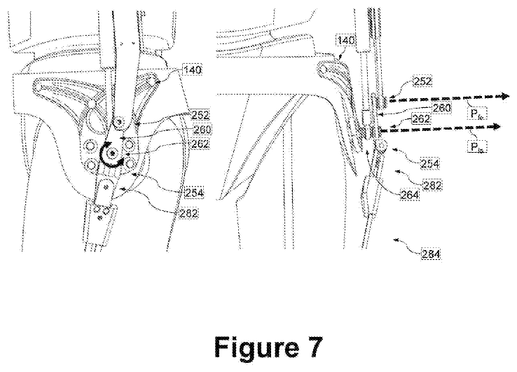

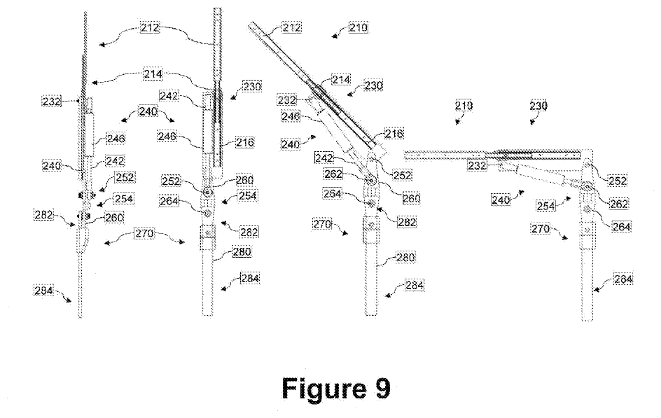

As best seen in FIG. 9, the bottom guiding member 216 is secured inside the left housing 230 such that the sliding member 214 slides in and out the bottom guiding member 216 inside the left housing 230. The left housing 230 also comprises the left spring-loaded mechanism 240 which is pivotably connected to a housing pivot axis 232 inside an upper section of the left housing 230 and which is parallel to the bottom guiding member 216 when the subject 5 is standing up. A bottom section of the left housing 230 is pivotably coupled to a left pivot member 260 to form a hip flexion-extension joint 252 which defines a pivot axis Pfe, as best seen in FIG. 7.

It will be appreciated that in one or more other embodiments, the left spring-loaded mechanism 240 may be in series with the bottom guiding member 216 within the left housing 230. In one or more alternative embodiments, the sliding mechanism 210 may be located above the left spring-loaded mechanism 240.

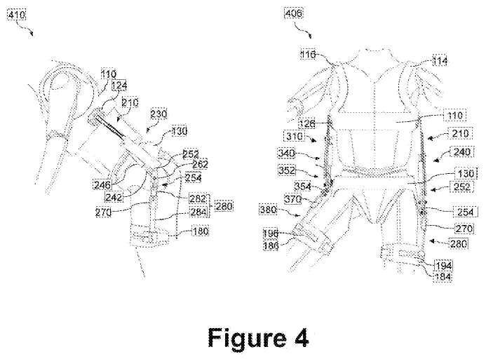

As best seen in FIG. 4 and FIG. 9, the left spring-loaded mechanism 240 is pivotably coupled to the housing pivot axis 232 in an upper section inside the left housing 230 and comprises a compression spring 246 and a lever member 242.

The lever member 242 is pivotably coupled to the left pivot member 260 below the hip flexion-extension joint 252 at a lever pivot axis 262 such that when the subject 5 wearing the exoskeleton 100 is standing up, the left sliding mechanism 210 and left lever member 242 are parallel to each other and when the subject 5 performs a frontal hip flexion, the lever member 242 pivots about the lever pivot axis 262 and the housing pivot axis 232 and thereby compresses the compression spring 246. During the frontal hip flexion movement, the compression spring 246 stores mechanical energy and is biased against the left housing axis 232 and the lever pivot axis 262. During frontal hip extension, the mechanical energy stored in the compression spring 246 is transmitted to the lever member 242 at the left housing axis 232 and at the lever pivot axis 262 to the pivot member 260 to aid the hip extension movement. Thus, the left and right spring-loaded mechanisms 240, 340 transmit forces, alleviate pressure on the lower back and enable the subject 5 to lift weights, bend its lower back repetitively and minimize risk of injury.

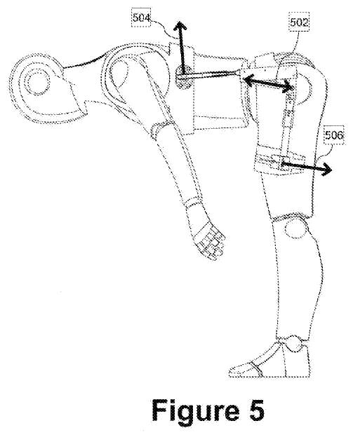

FIG. 5 illustrates a force diagram where it can be seen that the compression spring generates opposing forces 502 at the lever pivot axis 262 and the housing axis 232, the opposing forces 502 having a first force component 504 that is transmitted to the torso attachment 110 towards the back of the subject 5 and a second force component 506 that is transmitted to the thigh attachments 180 towards the back of the subject 5 to aid the frontal hip extension movement.

As best seen in FIG. 7, the left pivot member 260 comprises a left pivot link 264 that is pivotably connected to the left flap interface 140 and defines a left hip pivot 262 that couples the left exoskeleton mechanism 200 to the waist attachment 130. The left hip pivot 262 defines a left pivot axis P_{Ia}. Thus, the connection of the left pivot member 260 to the left flap interface 140 via the left hip pivot 262 enables maintaining the left pivot axis P_{Ia} normal to the skin during movement of the subject 5 and enables the subject 5 to perform frontal flexion of his left thigh.

The left pivot member 260 is rotatively connected to an upper section 282 of the thigh member 280 to define a left abduction-adduction joint 254. The left abduction-adduction joint 254 defines a left abduction-adduction axis (not shown) parallel to the sagittal plane 12 such that the subject 5 may perform abduction-adduction movements with his left leg, e.g. move his thigh in the frontal plane 14.

The upper section 282 of the thigh member 280 is parallel and operatively connected to a lower section 284 of the thigh member 280 via a thigh coupling mechanism 270. The thigh coupling mechanism 270 enables engaging and disengaging the left spring-loaded mechanism 240 by engaging the thigh member 280 with the pivot member 260, which enables free movement of the subject 5 without the left spring-loaded mechanism 240 storing and releasing energy.

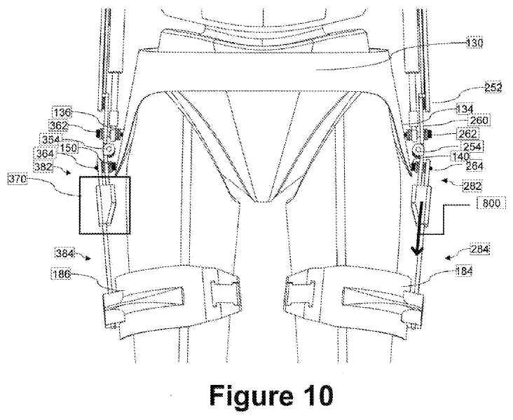

As best seen in FIG. 10, the subject 5 may disengage the left thigh coupling mechanism 270 by moving the left thigh coupling mechanism 270 downwardly.

The subject 5 may engage the left thigh coupling mechanism 270 by moving the left thigh coupling mechanism 270 upwardly.

It will be appreciated that the thigh coupling mechanism 270 may be implemented using different components that enable engaging and disengaging the left spring-loaded mechanism 240 from the rest of the left exoskeleton mechanism 200 such that the subject 50 may bend and move freely without the left spring-loaded mechanism 240 storing and releasing mechanical energy.

In one or more alternative embodiments, the thigh coupling mechanism 270 may be omitted and the upper section 282 of the thigh member 280 and the lower section 284 of the thigh member 280 may be integral.

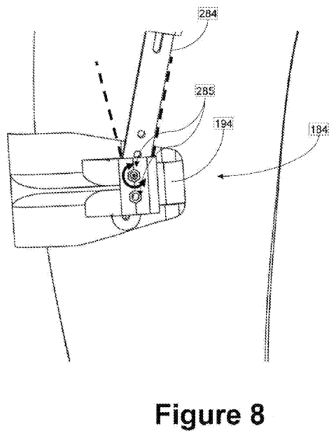

As best seen in FIG. 8, the lower section 284 of the thigh member 280 of the left exoskeleton mechanism 200 is rotatively coupled to the left thigh interface 194 via thigh links 285 to enable restricted rotative motion of the left exoskeleton mechanism 200 in the sagittal plane 12 at the hip of the subject 5 so as to minimize pressure points on the skin of the subject and discomfort of the subject 5.

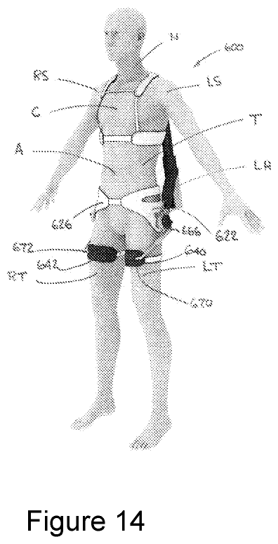

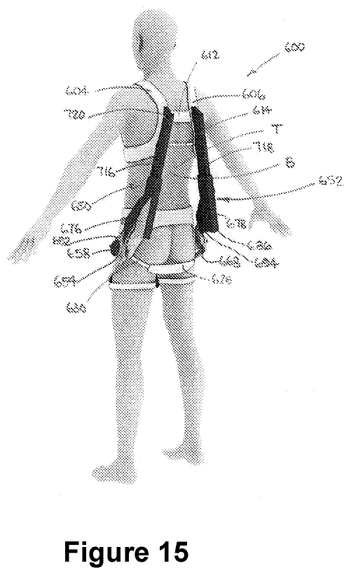

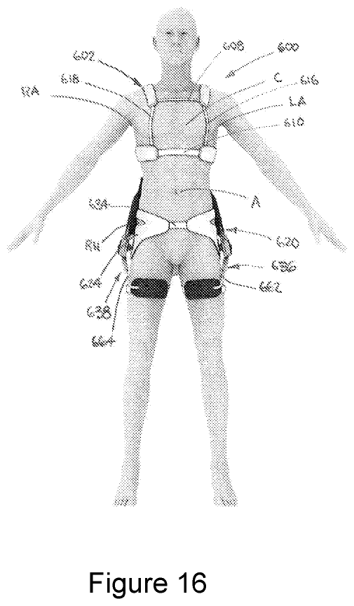

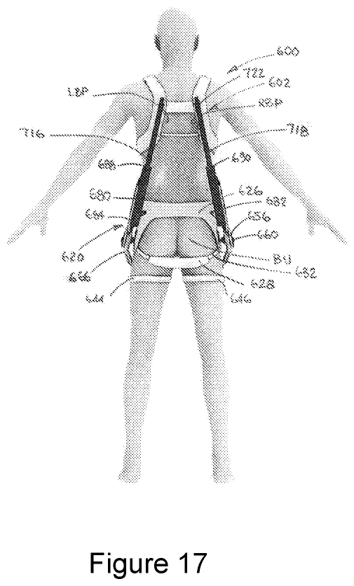

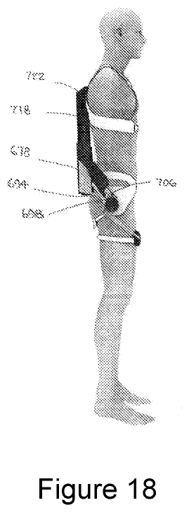

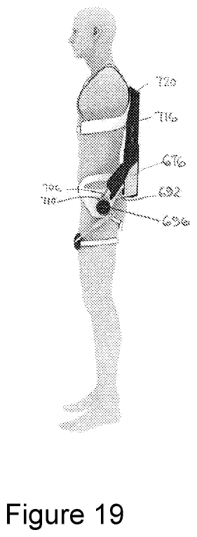

FIGS. 14 to 19 show views of an exoskeleton 600 in accordance with a second embodiment and being worn by a subject.

The subject has a neck N, left and right shoulders LS, RS, left and right armpits LA, RA, a chest C, a trunk T, an abdomen A, left and right hips LH, RH, a back B with left and right back portions LBP, RBP, a buttock BU, and left and right thighs LT, RT.

The exoskeleton 600 comprises a top portion 602 adapted to be worn on the subject's left and right shoulders LS, RS and chest C. The top portion 602 comprises top left and right bands 604, 606 at least partially covering the subject's chest C, left and right shoulders LS, RS, left and right side portions below the left and right armpits LA, RA, and left and right back portions LBP, RBP of the back B. At the front, generally proximate or below the chest C, the top portion 602 comprises a first front strap 608 between the top left and right bands 604, 606, and generally below the neck N, a second front strap 610 between the top left and right bands 604, 606. The first front strap and/or the second front strap 610 may comprise an attachment means such as a buckle or a VELCRO attachment. At the back, the top portion 602 comprises a top back band 612 between the left and right bands 604, 606, the top back band 612 at least partially covering the back B.

Below the top back band 612, the top portion 602 comprises a top back strap 614 between the left and right bands 604, 606, the top back strap 614 at least partially covering the back B. The top left and right bands 604, 606 may comprise left and right front straps 616, 618 at the front and each of the left and right front straps 616, 618 may comprise an attachment means such as a buckle.

The exoskeleton 600 also comprises a bottom portion 620 adapted to be worn on the subject's left and right hips LH, RH and back B. The bottom portion 620 comprises left and right flaps 622, 624 covering at least partially left and right sides of the subject's left and right hips LH, RH and left and right thighs LT, RT. The bottom portion 620 comprises a waist band 626 at least partially covering the subject's abdomen A, left and right hips LH, RH, and back B, a bottom back band 628 at least partially covering the subject's buttock BU, and bottom left and right back straps 630, 632 between the bottom back band 628 and the left and right flaps 622, 624. At the back, the waist band 626 may be generally proximate the subject's iliac crest or generally above the buttock BU such that the bottom portion 620 remains in place. In addition, the bottom back band 628 may be generally below the buttock BU with the bottom left and right back straps 630, 632 for providing suitable pressure on the subject and for maintaining the bottom portion 620 in place. At the front, the bottom portion 620 comprises a bottom front strap 634 that may comprise an attachment means such as a buckle or a VELCRO attachment.

The exoskeleton 600 further comprises left and right thigh portions 636, 638 adapted to be worn on the subject's left and right thighs LT, RT. The left and right thigh portions 636, 638 comprise left and right front plates 640, 642 at least partially covering left and right front portions of the subject's left and right thighs LT, RT and left and right thigh straps 644, 646 at least partially surrounding the left and right subject's thighs LT, RT.

The first and second front straps 608, 610, the top back strap 614, the left and right front straps 616, 618, the bottom left and right back straps 630, 632, the bottom front strap 634, and the left and right thigh straps 644, 646 may be made of a suitable (elastic) material and/or may have adjustment means or attachment means for providing suitable adjustment, comfort and tightness of the top portion 602, the bottom portion 620, and the left and right thigh portions 636, 638 on the subject.

The exoskeleton 600 also comprises left and right exoskeleton mechanisms 650, 652 comprising components for easing, aiding and/or supporting different movements of the subject while allowing the subject to walk without constraints and/or while allowing thigh flexion or extension and/or while allowing rotational trunk movement, trunk flexion and trunk extension of the subject with three degrees of freedom.

More particularly, the left and right exoskeleton mechanisms 650, 652 comprises left and right hip base members 654, 656 mounted to the left and right flaps 622, 624 of the bottom portion 620 and left and right hip members 658, 660 mounted to the left and right hip base members 654, 656.

It is understood that the left and right hip base members 654, 656 may at least partially overlay or cover left and right side portions of the subject's left and right thighs and/or left and right side portions of the subject's left and right hips and/or left and right back portions of the subject's left and right hips, and/or left and right side portions of the subject's buttock and/or left and right back portions of the subject's buttock.

The left and right exoskeleton mechanisms 650, 652 also comprises left and right thigh members 662, 664 extending between left and right proximal ends 666, 668 and left and right distal ends 670, 672. The left and right proximal ends 666, 668 of the left and right thigh members 662, 664 are mounted to the left and right hip base members 654, 656 and the left and right distal ends 670, 672 of the left and right thigh portions 662, 664 are mounted to the left and right thigh portions 636, 638 (to the left and right front plates 640, 642 of the left and right thigh portions 636, 638).

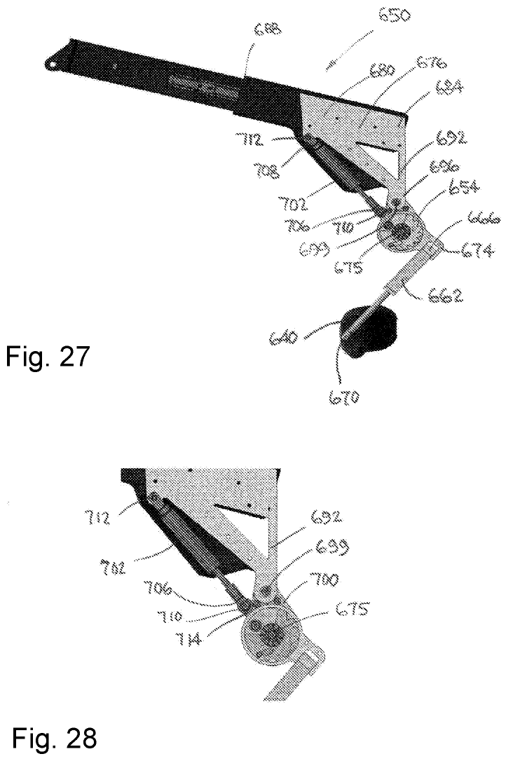

As seen in FIG. 27, each of the left and right hip base members 654, 656 may comprise a hip bottom projection 674 for allowing attachment of the left and right proximal ends 666, 668 of the left and right thigh members 662, 664 to the left and right hip base members 654, 656.

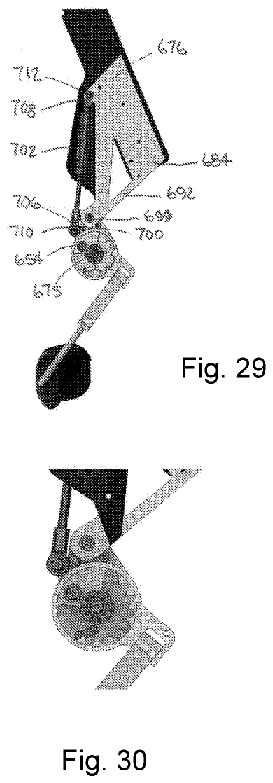

Movements of the left and right thigh members 662, 664 impart rotational movement of the left and right hip members 662, 664 relative to the left and right hip base members 654, 656 at left and right abduction-adduction joints (see left abduction-adduction joint 675 in FIGS. 27 and 29).

It is understood that the left and right thigh members 662, 664, the left and right hip base members 654, 656 and the left and right hip members 658, 660 are part of the bottom portion 620.

The left and right exoskeleton mechanisms 650, 652 further comprises left and right back members 676, 678 operatively connected to the left and right hip base members 654, 656.

The left and right back members 676, 678 comprise left and right longitudinal portions 680, 682 and extend upwardly from left and right bottom ends 684, 686 to left and right top ends 688, 690.

The left and right bottom ends 684, 686 of the left and right back members 676, 678 comprise left and right side members 692, 694 extending forwardly up to left and right distal ends 696, 698. The left and right distal ends 696, 698 are pivotably mounted to the left and right hip base members 654, 656 for allowing rotational movement of the left and right back members 676, 678 relative to left and right hip base members 654, 656 at left and right flexion joints upon movements of the left and right back members 676, 678 when the subject's trunk flexes or extends (see left flexion joint 699 in FIGS. 27, 28 and 29).

As seen in FIG. 29, each of the left and right hip base members 654, 656 may comprise a first hip top projection 700 for allowing attachment of the left and right distal ends 696, 698 of the left and right back members 676, 678 to the left and right hip base members 654, 656.

The left and right exoskeleton mechanisms 650, 652 also comprises left and right spring-loaded mechanisms 702, 704 operatively connecting the left and right back members 676, 678 to the left and right hip base members 654, 656.

Each of the left and right spring-loaded mechanisms 702, 704 extends between a bottom end 706 and a top end 708, the bottom end 706 being operatively connected to each the left and right hip base members 654, 656 at left and right bottom flexion-extension joints (see left bottom flexion-extension joint 710 in FIGS. 27, 28 and 29) and the top end of 708 being operatively connected to each of the left and right back members 676, 678 at left and right top flexion-extension joints (see left top flexion-extension joint 712 in FIGS. 27, 28 and 29). Each of the left and right hip base members 654, 656 may comprise a second hip top projection 714 for allowing attachment of the bottom end 706 of each of the left and right spring-loaded mechanisms 702, 704.

The left and right flexion joints and the left and right flexion-extension joints are adapted to enable a trunk flexion and a trunk extension of the subject in a sagittal plane

The left and right spring-loaded mechanisms 702, 704 are adapted to transfer a force to aid movement of the subject's left and/or right hips or to ease, aid and/or support different movements of the subject.

The left and right exoskeleton mechanisms 650, 652 also comprises left and right sliding members 716, 718 that are slidably movable relative to the left and right back members 676, 678 such that left and right lengths of the left and right sliding members 716, 718 vary upon a lateral flexion and/or a lateral extension of the subject.

It is understood that any slidable, retractable, telescopical constructions, or chain and sprocket construction, or any other suitable construction that allow movement of the sliding member relative to the back member wherein the length of the sliding member may increase or reduce upon a lateral flexion and/or a lateral extension of the subject are encompassed by the term “sliding movement” or “slidably movable”. In one variant, the left and right back members 676, 678 may comprise left and right guiding members defined by internal walls of the left and right back members 676, 678 and left and right bottom portions of the left and right sliding members 716, 718 may slidably engage within the left and right guiding members. The left and right back members 676, 678 may each have a hexagonal, square, rectangular, triangular, or circular shape and left and right bottom portions of the left and right sliding members 716, 718 may each have a corresponding hexagonal, square, rectangular, triangular, or circular shape for allowing sliding movement of the left and right sliding members 716, 718 relative to the left and right back members 676, 678.

The left and right sliding members 716, 718 extends between left and right bottom ends to left and right top ends 720, 722. The left and right top ends 720, 722 of the left and right sliding members 716, 718 are mounted to the top left and right bands 604, 606 at the back of the top portion 602 with left and right ball joints or with left and right universal joints for allowing rotational trunk movement, trunk flexion and trunk extension of the subject with three degrees of freedom. It is understood that the left and right top ends of the left and right sliding members may be mounted to left and right back portions of the top portion of the exoskeleton with left and right ball or universal joints.

While the left and right back members 676, 678 may be located at the left and right sides of the subject, and while left and right portion of the left and right side members 692, 694 may overlay left and right side portions of the subject, left and right top portions of the left and right back members 676, 678 may overlay left and right back portions of the subject.

While left and right bottom portions of the sliding members 716, 718 may partially overlay left and right back portions of the subject, the left and right top portions of the sliding members 716, 718 at least partially overlay left and right back portions of the subject for allowing mounting of the left and right sliding members 716, 718 to the top portion 602 of the exoskeleton 600 at the back of the subject.

It is understood that the sliding movement of the left and right sliding members 716, 718 relative to the left and right back members 676, 678 and/or the three degrees of rotation of the left and right joints at the left and right top ends 720, 722 of the left and right sliding members 716, 718 relative to the top portion 602 of the exoskeleton 600 allow rotational trunk movement, trunk flexion and/or trunk extension upon corresponding trunk movement, flexion and/or extension of the subject.

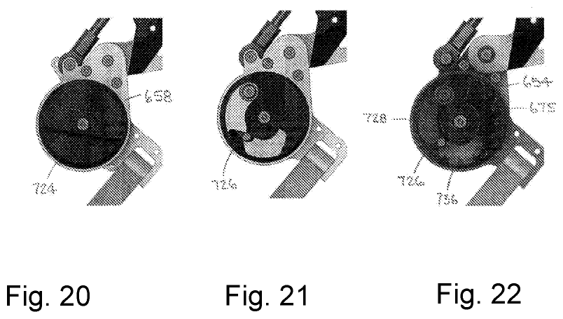

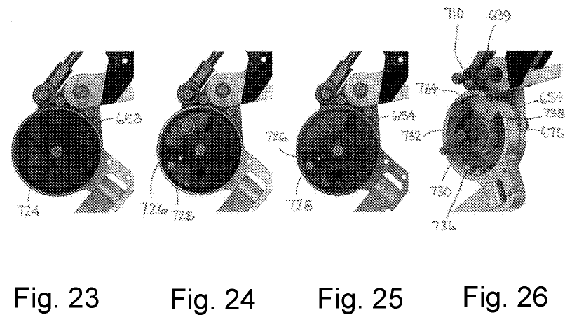

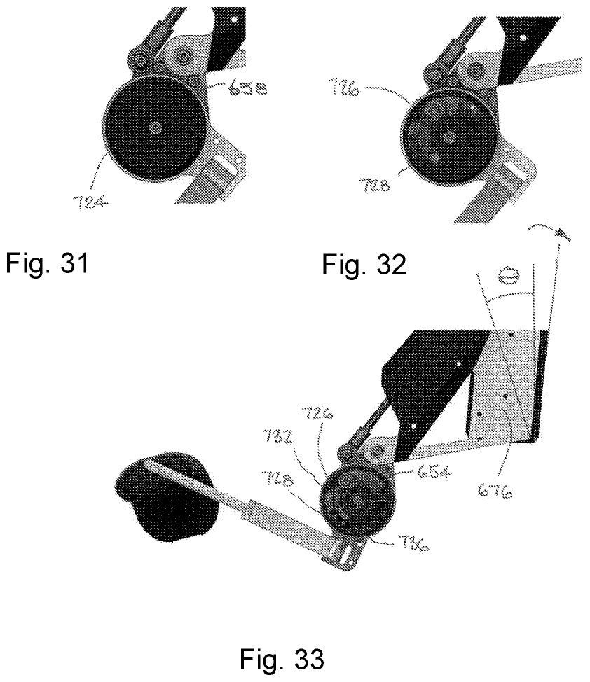

Referring to FIGS. 20, 23 and 31, each of the left and right exoskeleton mechanisms 650, 652 also comprises a cover 724 each mounted to the left and right hip members 658, 660. The cover 724 is rotatably movable between a first position shown in FIG. 20, a second position shown in FIG. 23, and a third position shown in FIG. 31.

Referring to FIGS. 21, 24 and 32, each of the left and right hip members 658, 660 or each of the left and right covers 724 comprises a projection 726 that is also rotatably movable between a first position shown in FIG. 21, a second position shown in FIG. 24, and a third position shown in FIG. 32.

Referring to FIGS. 22, 25 and 33, each of the left and right hip base members 654, 656 comprises an engaging member 728. In one variant, the engaging member 728 may be mounted to or be part of a distal end 730 of a pendulum 732 comprising a proximal end 734 pivotably mounted to each of the left and right hip base members 654, 656 at an axis of rotation that is above the left and right abduction-adduction joints 675, and below the left and right bottom flexion-extension joints 710 and left and right flexion joints 699. Each of the left and right hip members 658, 660 may comprise a plurality of engaging members 736 such as a plurality of teeth distributed over a portion of an internal peripheral wall of each of the left and right hip members 658, 660. As best seen in FIG. 26, the proximal end 734 of the pendulum is pivotably mounted to an inner wall 738 provided on each of the left and right hip base members 654, 656 and the engaging member 728 of the pendulum 732 extends outwardly.

As seen in FIGS. 21 and 22, in the first position, each of the left and right projections 726 contacts and pushes the engaging member 728 towards the abduction-adduction joint 675 such that the engaging member 728 cannot engage with the plurality of engaging members 736 and such that such that each of the left and right hip members 658, 660 freely rotate relative to the left and right hip base members 654, 656.

As seen in FIGS. 24 and 25, in the second position, each of the left and right projections 726, while still contacting the engaging member 728, each of the left and right projections 726 no longer pushes against the engaging member 728 such that the pendulum 732 with the engaging member 728 pivots towards the plurality of engaging members 736 for engaging between two of the engaging member 736 as seen in FIG. 26 and for locking together the left and right hip members 658, 660 and the left and right hip base members 654, 656 such that each of the left and right spring-loaded mechanisms 702, 704 transfers the force to aid movement of the subject left and/or right hips.

As seen in FIGS. 32 and 33, in the third position, each of the left and right projections 726 no longer contacts the engaging member 728 and the pendulum 732 with the engaging member 728 is free to pivot towards the plurality of engaging members 736 depending of the position of the left and right hip members 658, 660 relative to the left and right hip base members 654, 656.

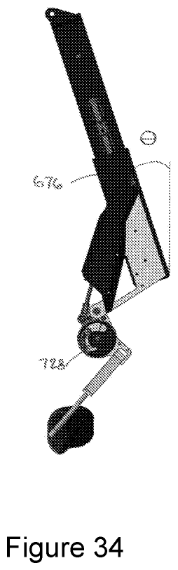

Because the engaging member 728 does not engage the plurality of engaging member 736, each of the left and right hip members 658, 660 may freely rotate relative to the left and right hip base members 654, 656 when the left and right back members 676, 678 move forwardly or rearwardly when the torso of the subject moves forwardly (flex) or rearwardly (straighten) as long as the torso of the subject does not reach an engaging angle ⊖. In FIG. 34, the left back member 676 is at an engaging angle ⊖ relative to a vertical axis that generally corresponds to a forward angle wherein the torso of the subject is flexed forwardly. The engaging angle may be between about 15° and about 25° relative to the vertical axis. In FIG. 33, the back member is rearwardly the engaging angle ⊖ (the back member may be generally straight or may be at an angle of about −3° relative to the vertical axis).

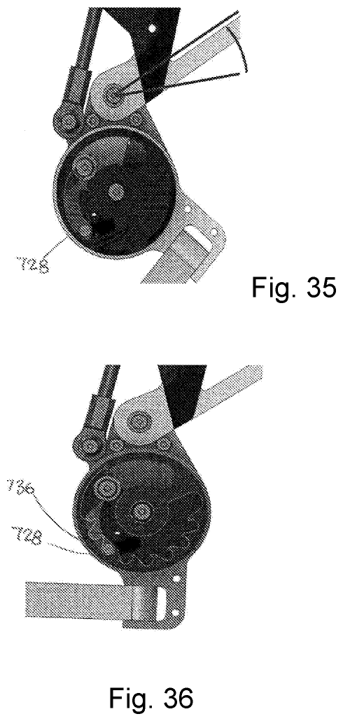

As such, when the left and right back members 676, 678 are each at the engaging angle ⊖ of about 15° to about 25°, each of the left and right engaging members 728 engages between two of the engaging members 736 to lock together the left and right hip members 658, 660 and the left and right hip base members 654, 656 such that the left and right spring-loaded mechanisms 702, 704 transfer the force to aid movement of the subject left and/or right hips (see FIGS. 34 to 36). When the left and right back members 676, 678 are each rearwardly the engaging angle ⊖, each of the left and right engaging members 728 no longer engage with the plurality of engaging members 736 and the left and right hip members 658, 660 are no longer lock with the left and right hip base members 654, 656 such that the left and right hip members 658, 660 may freely rotate relative to the left and right hip base members 654, 656 (see FIGS. 31 to 33).

It is understood that the length of the pendulum 732 and the position of the axis of rotation of the proximal end 734 of the pendulum 732 relative to the left and right abduction-adduction joints 675, the left and right bottom flexion-extension joints 710, the left and right flexion joints 699 and the other components are determined such that, when the left and right back members 676, 678 are each at the engaging angle ⊖ of about 15° to about 25°, the pendulum 732 with the engaging member 728 pivots towards the plurality of engaging members 736 to engage between two of the engaging members 736 and lock together the left and right hip members 658, 660 and the left and right hip base members 654, 656.

It will be appreciated that each of the exoskeletons 100, 600 provides freedom of movement to the subject in a variety of positions a result of the combination and positioning of the abduction-adduction joints, the flexion joints, the flexion-extension joints, the hip base members, the hip members, the thigh members, the back members, the sliding mechanisms, and the spring-loaded mechanisms.

The above description of the variants, examples or embodiments should not be interpreted in a limiting manner since other variations, modifications and refinements are possible within the scope of the present invention. Accordingly, it should be understood that various features and aspects of the disclosed variants or embodiments can be combined with or substituted for one another in order to form varying modes of the disclosed invention. For example, and without limitation, any individual element of the described variants or embodiments may be replaced by alternative elements that provide substantially similar functionality or otherwise provide adequate operation. This includes, for example, presently known alternative elements, such as those that might be currently known to a skilled person in the art, and alternative elements that may be developed in the future, such as those that a skilled person in the art might, upon development, recognize as an alternative. The scope is defined in the appended claims and their equivalents.

1. An exoskeleton to be worn by a subject having left and right shoulders, left and right armpits, a chest, an abdomen, left and right hips, a back, a buttock, and left and right thighs, the exoskeleton comprising:
a top portion adapted to be worn on the subject's left and right shoulders and chest;
a bottom portion adapted to be worn on the subject's left and right hips and back, the bottom portion comprising left and right flaps covering at least partially left and right sides of the subject's left and right hips and left and right thighs;
left and right thigh portions adapted to be worn on the subject's left and right thighs; and
left and right exoskeleton mechanisms comprising: (i) left and right hip base members mounted to the left and right flaps of the bottom portion, (ii) left and right hip members mounted to the left and right hip base members, (iii) left and right thigh members extending between left and right proximal ends and left and right distal ends, the left and right proximal ends of the left and right thigh members being mounted to the left and right hip base members and the left and right distal ends of the left and right thigh portions being mounted to the left and right thigh portions, (iv) left and right back members operatively connected to the left and right hip base members, (v) left and right spring-loaded mechanisms operatively connecting the left and right back members to the left and right hip base members, and (vi) left and right sliding members comprising left and right top ends mounted to the top portion of the exoskeleton, wherein movements of the left and right thigh members impart rotational movement of the left and right hip members at left and right abduction-adduction joints, wherein movements of the left and right back members impart rotational movement of the left and right back members relative to the left and right hip base members at left and right flexion joints, and wherein the left and right sliding members are slidably movable relative to the left and right back members such that left and right lengths of the left and right sliding members vary upon a lateral flexion and/or a lateral extension of the subject.

2. The exoskeleton of claim 1, wherein left and right bottom ends of the left and right spring-loaded mechanisms are operatively connected to the left and right hip base members at left and right bottom flexion-extension joints, wherein left and right top ends of the left and right spring-loaded mechanisms are operatively connected to the left and right back members at left and right top flexion-extension joints, and wherein the left and right spring-loaded mechanisms are adapted to transfer a force to aid movement of the subject's left and/or right hips.

3. The exoskeleton of claim 1, wherein the left and right back members define left and right guiding members and wherein left and right bottom portions of the left and right sliding members slidably engaged within the left and right guiding members.

4. The exoskeleton of claim 1, wherein the top portion of the exoskeleton comprises top left and right bands at least partially covering the subject's chest, left and right shoulders, left and right side portions below the left and right armpits, and left and right back portions and wherein the left and right top ends of the left and right sliding members are mounted to the top left and right bands at the subject's left and right back portions.

5. The exoskeleton of claim 4, wherein the top portion of the exoskeleton comprises first and second front straps between the top left and right bands.

6. The exoskeleton of claim 4, wherein the top portion of the exoskeleton comprises a top back band between the top left and right bands, the top back band at least partially covering the subject's back.

7. The exoskeleton of claim 1, wherein left and right bottom ends of the left and right back members comprise left and right side members extending forwardly up to left and right distal ends, the left and right distal ends of the left and right side members being pivotably mounted to the left and right hip base members at the left and right flexion joints.

8. The exoskeleton of claim 1, wherein the left and right thigh portions comprise left and right front plates at least partially covering left and right front portions of the subject's left and right thighs and left and right thigh straps at least partially surrounding the subject's left and right thighs and wherein the left and right distal ends of the left and right thigh members are mounted to the left and right front plates.

9. The exoskeleton of claim 1, wherein the bottom portion of the exoskeleton comprises a waist band at least partially covering the subject's abdomen, left and right hips, and back.

10. The exoskeleton of claim 1, wherein the bottom portion of the exoskeleton comprises a bottom back band at least partially covering the subject's buttock.

11. The exoskeleton of claim 1, wherein the bottom portion of the exoskeleton comprises a waist band at least partially covering the subject's abdomen, left and right hips, and back, a bottom back band at least partially covering the subject's buttock, and bottom left and right back straps between the bottom back band and the left and right flaps.

12. The exoskeleton of claim 1, wherein the left and right sliding members are adapted to enable a rotational trunk movement of the subject.

13. The exoskeleton of claim 1, wherein each of the left and right spring-loaded mechanism comprises a lever and a compression spring.

14. The exoskeleton of claim 1, wherein the left and right top ends of the left and right sliding members are mounted to left and right back portions of the top portion of the exoskeleton with left and right ball joints or with left and right universal joints for allowing rotational trunk movement, trunk flexion and trunk extension of the subject with three degrees of freedom.

15. The exoskeleton of claim 1, wherein the left and right hip base members and the left and right hip members overlay left and right femoral joints of the subject when the exoskeleton is worn by the subject.

16. The exoskeleton of claim 1, comprising left and right engaging members for selectively engaging and disengaging the left and right spring-loaded mechanisms.

17. The exoskeleton of claim 16, comprising left and right covers mounted to the left and right hip members, wherein the left and right hip members or the left and right covers comprise left and right projections, wherein the left and right covers are rotatable between left and right first positions, wherein the left and right covers are rotatable between left and right first positions, wherein the left and right projections push the left and right engaging members such that the left and right hip members freely rotate relative to the left and right hip base members, and left and right second positions, wherein the left and right projections allow the left and right engaging members to lock together the left and right hip members and the left and right hip base members such that the left and right spring-loaded mechanisms transfer the force to aid movement of the subject left and/or right hips.

18. The exoskeleton of claim 17, wherein the left and right covers are rotatable to left and right third positions wherein the left and right projections no longer contact the left and right engaging members, wherein, at an engaging angle of the left and right back members relative to a vertical axis, the left and right engaging members lock together the left and right hip members and the left and right hip base members such that the left and right spring-loaded mechanisms transfer the force to aid movement of the subject left and/or right hips, and wherein, when the left and right back members are rearwardly the engaging angle, the left and right engaging members no longer lock together the left and right hip members and the left and right hip base members such that the left and right hip members freely rotate relative to the left and right hip base members.

19.-36. (canceled)
